(19) United States
(12) Patent Application Publication
(10) Pub. No.: US 2011/0112907 A1
(43) Pub. Date: May 12, 2011

(54) SYSTEM AND METHOD FOR PROVIDING ADVERTISEMENT SERVICE BY USING TEXT MESSAGES

(76) Inventor: Jang Won Seo, Seoul (KR)

(21) Appl. No.: 13/003,763

(22) PCT Filed: Jun. 23, 2009
(86) PCT No.: PCT/KR2009/003377

§ 371 Date: Jan. 11, 2011

(30) Foreign Application Priority Data
Jul. 11, 2008 (KR) 10-2008-0067755

(51) Int. Cl. G06Q 30/00

(52) U.S. Cl. 705/14.64; 705/14.4

(57) ABSTRACT

The present invention relates to a system and a method for providing an advertisement service by using a text message, which provide advertisement content when a user uses a text message service. The method of the present invention comprises: When a text message is transmitted from a mobile terminal through a mobile communication network, an SMS server requesting an advertising system to transmit advertisement content, depending on whether or not there is a request for the reproduction of the advertisement content; the advertising system selecting the advertisement content and transmitting the advertisement content to the mobile terminal through the mobile communication terminal; the mobile terminal storing the advertisement content transmitted from the advertisement system; and if a transmission key is inputted for the transmission of the text message, the mobile terminal reproducing the advertisement content, which are stored during the transmission of the previous is text message, while transmitting the text message to the SMS server.

### TECHNICAL FIELD

The present invention relates to a method for providing advertisement service, and in particular to a system and a method for providing an advertisement service by using text messages which are directed to providing advertisement content when using a text message service.

### BACKGROUND ART

A personal communication service is a low cost and universal type mobile service which can perform a voice and low speed data communication irrespective of place and time by using a mobile terminal.

The current wired/wireless communication network is mainly provided for a voice communication, but in recent years as a data service subscriber continues to increase, the service becomes widespread to the field of a non-voice service field like a data service.

The short message service (SMS) is basically provided for transmitting and receiving a short sentence of less than about 40 characters long between mobile terminals or a personal computer connected in the internet and a mobile terminal.

It can be transferred to a receiver in almost real time different from e-mail, and even when a mobile terminal remains turned off, and an opponent user is in a non-service area, the message can be stored for a couple days as compared to a wireless call service, so the SMS is one of the important communication means.

In recent years, lots of advertisement owners or advertisement service providers consider requesting advertisements by using the SMS.

Various kinds of advertisement services are provided by using to mobile terminals, and the advertisement services using the mobile terminals are designed so that a caller is given a communication service for free or a discounted rate when he hears a corresponding advertisement for a certain time.

The above prior art is provided for the purpose of understanding the background of the present invention, not meaning the conventional art widely is known in the technical field to which the present invention pertains.

In the method for advertising by using a SMS in the prior art, an advertisement owner or an advertisement service provider is basically directed to transmitting without having consent from a receiver.

The receiver might receive a non-requested SMS which results in an uneasiness to a receiver, so the receiver might delete without confirming the content of the message transmitted to him, which leads to a poor performance in the SMS advertisement. A text message management might be difficult since a user could delete a corresponding advertisement.

### DISCLOSURE OF INVENTION

Accordingly, it is an object of the present invention to provide a system and a method for providing an advertisement service by using text messages in which an advertisement content is stored in a mobile terminal of a sender by transmitting an advertisement content in the course of transmission of a text message in response to an input of a text message transmission of a mobile terminal of a sender, and when a transmission key is inputted for another text message transmission, a previously stored advertisement content is reproduced in the course of text message transmission.

It is another object of the present invention to provide a system and a method for providing an advertisement service by using text messages in which it is possible to transmit a text message at low cost without causing a sender to hear an advertisement and it is possible to send advertisements without providing any uneasiness to an advertisement owner by providing an advertisement content in the course of a text message transmission.

To achieve the above objects, the present invention discloses the following constructions.

The system for providing an advertisement service by using text messages comprises a SMS (Short Message Service) for checking whether or not there is an advertisement content reproduction request when a text message is transmitted from a mobile communication network and requesting the advertisement content when there is an advertisement content reproduction request; an advertisement system for storing the advertisement content and reading and transmitting the advertisement content when there is an advertisement content request from the SMS server; and a mobile terminal for transmitting a text message to the SMS server via the mobile communication network when a text message transmission key is inputted and for storing the advertisement content transmitted from the advertisement system when the advertisement content is transmitted from the advertisement system in the is course of the text message transmission and for reproducing the advertisement content stored in the course of the previous text message transmission while the text message is being transmitted.

The mobile terminal divides a screen and displays the information which shows that the advertisement content and the text messages are being transmitted.

The mobile terminal displays a selection window for selecting whether or not the advertisement content is reproduced when a transmission key for the text message transmission is inputted, for thereby selecting whether or not the advertisement content is reproduced.

The advertisement system is directed to transmitting by selecting the advertisement content depending on the personal information of the sender.

The advertisement content includes a motion image, a still image and text.

The method for providing an advertisement service by using text messages comprises a step in which when a text message is transmitted from a mobile terminal via a mobile communication network, a SMS (Short Message Service) requests an advertisement content to an advertisement system depending on whether or not there is an advertisement content reproduction request, and the advertisement system selects the advertisement content; a step in which the advertisement system transmits the advertisement content to the mobile terminal via the mobile communication network; a step in which the is mobile terminal stores the advertisement content transmitted from the advertisement system; and a step in which when a transmission key is inputted for a text message transmission after the mobile terminal stores the advertisement content, the advertisement content stored while the previous text message is being transmitted is reproduced while the text message is being transmitted to the SMS server.

When a transmission key is inputted from the text message transmission, the mobile terminal displays a selection window for selecting whether or not the advertisement content is reproduced, for thereby selecting whether or not the advertisement content is reproduced.

The advertisement content is selected depending on a personal information of a sender and is sent.

The advertisement content includes a motion image, a still image and text.

The mobile terminal divides a screen for displaying an information which shows that the advertisement content and the text message are being sent and displays the same.

### EFFECTS

In the present invention, an advertisement service provider provides a sender with an advertisement content when using a SMS, and the advertisement service provider pays the charges for the use of the SMS on behalf of the user of the SMS, so it is possible for the sender to use a SMS without paying any charges for the use of the SMS while the advertisement service provider can enhance advertisement effects.

### BRIEF DESCRIPTION OF THE DRAWINGS

The present invention will become better understood with reference to the accompanying drawings which are given only by way of illustration and thus are not limitative of the present invention, wherein;

FIG. 1 is a block diagram of a system for providing an advertisement service by using text messages according to an embodiment of the present invention;

FIG. 2 is a flow chart of an advertisement content download based on the use of a text message according to an embodiment of the present invention;

FIG. 3 is a flow chart of an advertisement content reproduction procedure based on the use of a text message according to an embodiment of the present invention; and

FIG. 4 is a view of a screen of a mobile terminal which reproduces an advertisement content according to an embodiment of the present invention.

### DESCRIPTIONS OF REFERENCE NUMERALS OF MAJOR ELEMENTS OF DRAWINGS

10: mobile terminal

20: mobile communication network

30: SMS server

40: charging server

50: advertisement system

51: advertisement server

52: advertisement content DB

### MODES FOR CARRYING OUT THE INVENTION

The method for providing an advertisement service by using a text message according to an embodiment of the present invention will be described with reference to the accompanying drawings.

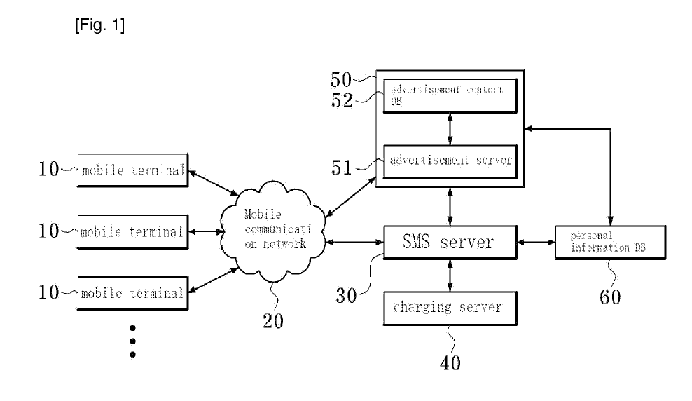

FIG. 1 is a block diagram of a system for providing an advertisement service by using a text message according to an embodiment of the present invention.

The system for providing an advertisement service by using a text message according to an embodiment of the present invention comprises a mobile terminal 10, a mobile communication network 20, a SMS server 30, a charging server 40, an advertisement system 50, and a personal information DB 60.

For reference, it is assumed that the text message includes a MMS which contains a motion image, a motion video or a color mail.

The mobile terminal 10 allows the user to input text messages by using various keys formed on a key pad (not shown), and the text messages are requested for the transmission to the SMS server 30. Here, when a transmission key (not shown) for a text message transmission provided at the mobile terminal 10 is inputted, a selection window in which the user is asked to is determine whether an advertisement content is reproduced or not in the course of the text message transmission is shown, so the sender can select an advertisement content download and reproduction. In addition, the text message from the SMS server 30 is displayed, and the advertisement content from the advertisement system 50 is stored and reproduced depending on the selection of the user via the selection window.

In this case, the mobile terminal 10 divides the information which shows that the advertisement content and the text messages are being transmitted, so that the sender can confirm that the text message is being transmitted while watching the advertisement content.

When the text message is received from the mobile terminal 10, the SMS server 30 transmits the text message to the mobile terminal 10 of the receiver. In this case, when the text message is transmitted, the SMS sever 30 confirms whether there is an advertisement content reproduction request, and when there is an advertisement content reproduction request, the SMS server requests an advertisement content to the advertisement server 51.

The personal information DB 70 stores the personal information such as the name, age, sex, address, telephone number, occupation, favorite field and address and residence region of the sender and the receiver. Here the personal information is used when confirming the telephone number of the is sender who requested the text message transmission and selecting an effective advertisement content to the sender. In particular, at least one of the age, sex, occupation, favorite field and region information can be used for the advertisement content selection.

The advertisement system 50 is used for extracting the advertisement content and transmitting to the mobile terminal 10 of the sender via the mobile communication network 20 and includes an advertisement server 51 and an advertisement content DB 52.

When an advertisement content provision is requested from the SMS server 30, the advertisement server 51 extracts a personal information of a corresponding sender stored in the personal information DB 60 while the text message is being transmitted to the mobile terminal of the receiver and reads the advertisement content from the advertisement content DB 52 based on the personal information and transmits to the mobile terminal 10 of the sender who requested the advertisement content reproduction.

The advertisement content DB 52 includes a text, image, 3D image, etc. such as a company logo, a product information, etc.

The advertisement server 51 can transmits different advertisement content by senders. In this case, a proper advertisement content is selected depending on the personal information of the sender such as age, sex, favorite field, address, and regional information such as a residing area. In particular, the favorite field is generally asked when a user subscribes a mobile communication company by using the mobile terminal 10 in order for the mobile communication company to provide various services or advertisement content to a corresponding customer, but the inputs of such information are just optional when subscribing the mobile communication company. However, the inputted personal information helps give the sender, who requested the transmission of the text message, advertisement content benefiting the sender. In particular, the regional information including a regional product or tour sites helps enhance the advertisement effects in the region where the sender resides as compared to the other region.

The charging server 60 helps provide some discounted service charges to a corresponding sender by registering a use charge based on the use of the service in accordance with an advertisement content provision in case of the text message service.

The example that a discount benefit is provided to the sender who requested the advertisement content provision, by using the charging server 60 when using the text services, has been described in the above, but the present invention is not limited thereto. In addition to the discount benefits with respect to the charges, various economical benefits can be provided to the sender who is requested the advertisement content provision, for example, some free products of a corresponding company can be given or event participation tickets can be given to the sender. In this case, the information registered in the charging server 60 corresponds to the information concerning various benefits such as free product information or event information.

The mobile communication network 20 comprises a base station (not shown) which exchanges information with the mobile terminal 10 via a transmission and receiving antenna, a base station controller (not shown) for performing a base station management function such as a system loading error management, etc. while performing a wired and wireless channel management terminal protocol match and a base station protocol match and control, a switch (not shown) which performs a central control function for processing the signals from the base station and adjusting so that the base station can efficiently be operated, and a home position register (not shown) which informs various information such as a transmission and receipt state of a subscriber, a value to added service, etc. and a subscriber's position.

The mobile communication terminal 20 is a common wireless network which transmits and receives a text message, audio data and various signals. The description of the same will be omitted because it can be easily adapted by those skilled in the art.

The mobile communication company generally makes an agreement with a main hosting company in order to provide mail information including a text message to users. When the mail is received, the mobile communication company provides the main information received from the main hosting company, for example, mail title, email address of sender and received time of main, to the text message user.

Here, the process that the text message containing the main information received by the user is transmitted to the mobile terminal 10 of the receiver is performed as follows: the SMS server 30 reads a main information from the mail server at regular intervals, and the SMS server 30 creates a text message, based on the read main information, including the text message for informing that the mail is received, namely, creates the text message containing the received main information, and transmits to the mobile terminal 10 of the receiver.

The process that various text messages are transmitted to the mobile terminal 10 of the sender by using the mobile communication network 20 can be easily implemented by those skilled in the art, so the descriptions of the same will be omitted.

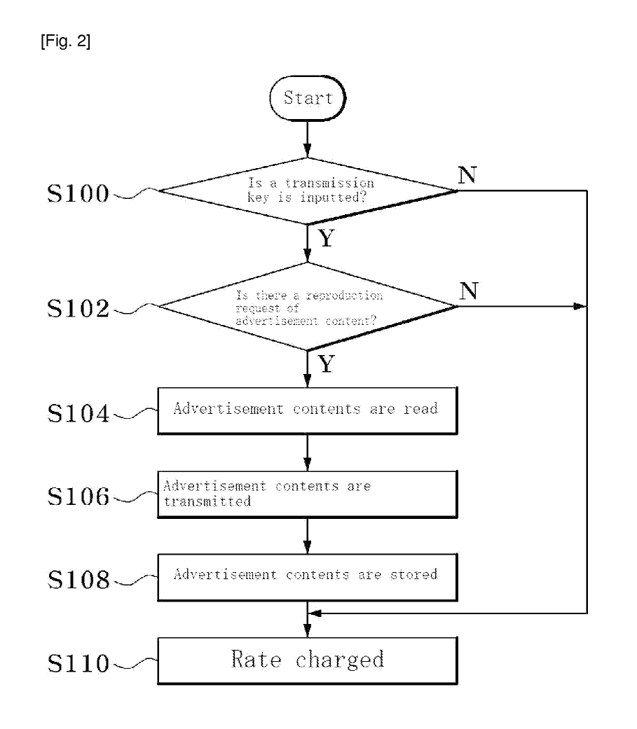

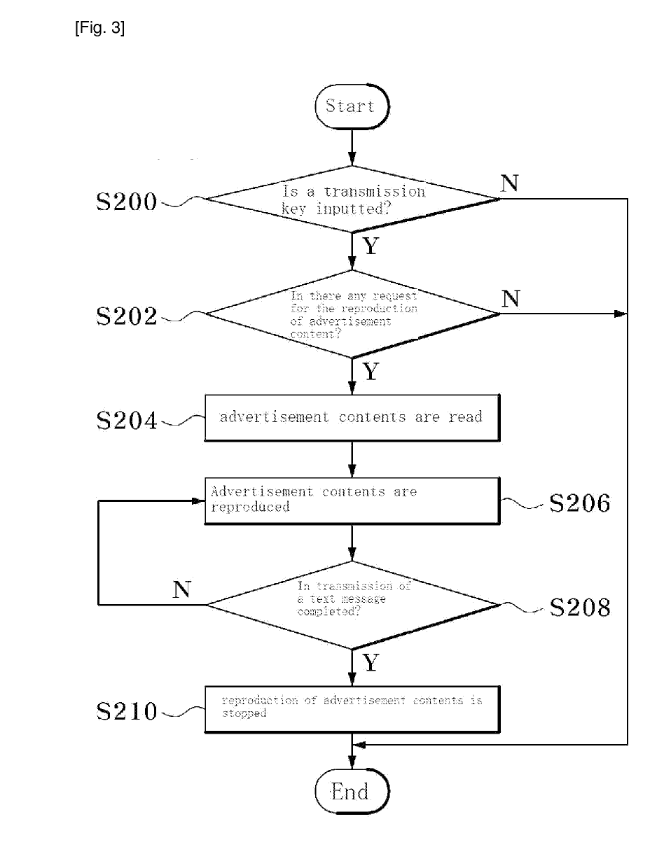

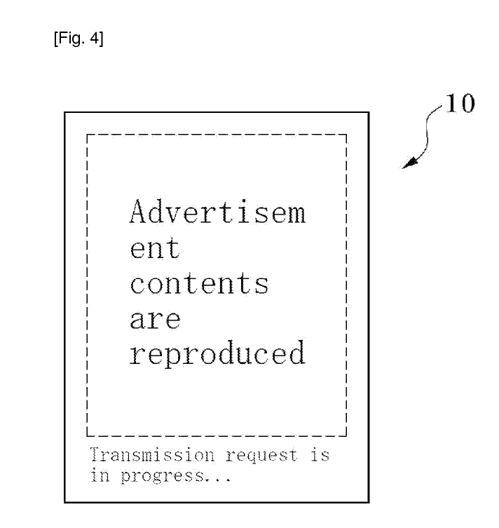

FIG. 2 is a flow chart of an advertisement content download based on the use of a text message according to an embodiment of the present invention, and FIG. 3 is a flow chart of an advertisement content reproduction procedure based on the use of a text message according to an embodiment of the present invention, and FIG. 4 is a view of a screen of a mobile terminal which reproduces an advertisement content according to an embodiment of the present invention.

The method for providing an advertisement service by using a text message according to an embodiment of the present invention comprises a step in which a text message is transmitted from a mobile terminal 10 of a sender to a SMS server 40, a step in which an advertisement content is stored into the mobile terminal 10 of the sender, and a step in which the mobile terminal 10 of the sender reproduces the stored advertisement content.

The process in which the text message is transmitted from the mobile terminal 10 of the sender, and the advertisement system 50 transmits the advertisement content to the mobile terminal 10 of the sender and stores the same will be described. First of all, the mobile terminal 10 of the sender confirms whether or not a transmission key is inputted, which allows the made text message to be transmitted to the mobile terminal 10 of the sender in Step S100.

At this time, when the transmission key is inputted, the mobile terminal 10 of the sender displays a selection window for selecting whether or not the advertisement content is reproduced based on the text message, for thereby selecting whether or not the advertisement content is reproduced in Step S102.

In this case, when the sender selects an advertisement content reproduction, the portable terminal 10 of the transmitter transmits the text message to the SMS server 30 via the mobile communication network 20.

When the text message is transmitted, the SMS server 30 confirms whether or not there is an advertisement content reproduction request, and at this time, when there is an advertisement content reproduction request, the SMS server 30 requests an advertisement content to the advertisement system 50.

The advertisement server 51 extracts a telephone number of the sender and a personal information of a corresponding sender from the personal information DB 70 and selects and reads in Step S104 a proper advertisement from the advertisement content DB 52 depending on the personal information and transmits in Step S106 to the mobile terminal 10 of the sender via the mobile communication network 20.

In this case, the advertisement content is selected based on the sex, age, occupation, favorite field and regional information of the sender and is transmitted.

When the advertisement content is transmitted from the advertisement system 50, the mobile terminal 10 of the sender stores the transmitted advertisement content in Step S108.

When the advertisement content is transmitted from the advertisement system 50, the charging server 40 registers the charges depending on the advertisement content transmission.

It generally takes 2-5 seconds when transmitting the text message from the mobile terminal 10 of the sender to the mobile terminal 10 of the sender, and in case of heavy traffic in text transmission, it takes 10˜20 seconds. In this case, a certain message such as “the transmission is in progress” is indicated in order to show the request of the text message transmission, and a certain image or motion image can be displayed to inform that the text message transmission is in progress.

When the text message is stored, the mobile terminal 10 of the sender reproduces the stored text messages. The above procedure will be described with reference to FIG. 4.

In the procedure for reproducing the text messages, when the user inputs a text message, it is confirmed whether or not the transmission key is inputted in Step S200.

When the transmission key is inputted, the mobile terminal 10 displays a selection window for selecting and reproducing a certain content, and is it is confirmed whether or not the sender reproduces an advertisement content in Step S202.

At this time, when the sender selects an advertisement content to reproduce, the mobile terminal 10 reads in Step S204 the text message downloaded and stored based on the use of the previous text message from the memory (not shown) and reproduces in Step 206 as shown in FIG. 4.

In this case, the mobile terminal 10 first reproduces the latest transmitted advertisement content when the previously stored advertisement content are at least two or randomly reads and reproduces at least two to advertisement content.

It is confirmed whether or not the text message transmission is finished in Step S208, and when the text message transmission is completed, the advertisement content reproduction is stopped in Step S210.

In the method for providing an advertisement service by using text is messages according to an embodiment of the present invention, the mobile terminal 10 receives and stores an advertisement content from the advertisement system 50 while the text message is being transmitted from the mobile terminal 10 of the sender to the mobile terminal 10 of the receiver, and the advertisement content, which was previously stored while the text message was previously being transmitted to the mobile terminal 10 of the receiver, is reproduced while the text message is being transmitted to the mobile terminal 10 of the receiver.

In the method for providing an advertisement service by using text message according to an embodiment of the present invention, the user provides an advertisement content to the sender, and the charges for the use of the SMS is paid by the advertisement service provider on behalf of the user, so the sender does not pay the charges for the use of the SMS when using the SMS.

In the embodiment of the present invention, the advertisement system 50 has been described as it is separately provided for detecting the advertisement content and transmitting the same when the text message is requested, but it is not limited thereto. It can be provided as being directly linked with the SMS server 30.

In the method for providing an advertisement service by using text messages according to an embodiment of the present invention, a user who uses an advertisement service can obtain advertisement effects, and the sender can use the SMS for free or at discounted rate with respect to the charges for the use of the SMS. In addition, the user who uses the advertisement services can economically advantageously enjoy the free use or discounted rate for the charges for the use of the SMS as well as free products or points for thereby is increasing the number of advertisement service users. So, the advertisement owner can obtain a lot of advertisement effects while looking for a new advertisement medium based on the above economical merits.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A system for providing an advertisement service by using text messages, comprising:
a SMS (Short Message Service) for checking whether or not there is an advertisement content reproduction request when a text message is transmitted from a mobile communication network and requesting the advertisement content when there is an advertisement content reproduction request;
an advertisement system for storing the advertisement content and reading and transmitting the advertisement content when there is an to advertisement content request from the SMS server; and
a mobile terminal for transmitting a text message to the SMS server via the mobile communication network when a text message transmission key is inputted and for storing the advertisement content transmitted from the advertisement system when the advertisement content is transmitted from the is advertisement system in the course of the text message transmission and for reproducing the advertisement content stored in the course of the previous text message transmission while the text message is being transmitted.

2. A system for providing an advertisement service by using text messages according to claim 1, wherein said mobile terminal divides a screen and displays the information which shows that the advertisement content and the text messages are being transmitted.

3. A system for providing an advertisement service by using text messages according to claim 1, wherein said mobile terminal displays a selection window for selecting whether or not the advertisement content is reproduced when a transmission key for the text message transmission is inputted, for thereby selecting whether or not the advertisement content is reproduced.

4. A system for providing an advertisement service by using text to messages according to claim 1, wherein said advertisement system is directed to transmitting by selecting the advertisement content depending on the personal information of the sender.

5. A system for providing an advertisement service by using text is messages according to claim 4, wherein said personal information of the sender is at least one of age, sex, occupation and regional information.

6. A system for providing an advertisement service by using text messages according to claim 1, wherein said advertisement content includes a motion image, a still image and text.

7. A method for providing an advertisement service by using text messages, comprising:
a step in which when a text message is transmitted from a mobile terminal via a mobile communication network, a SMS (Short Message Service) requests an advertisement content to an advertisement system depending on whether or not there is an advertisement content reproduction request, and the advertisement system selects the advertisement content;
a step in which the advertisement system transmits the advertisement content to the mobile terminal via the mobile communication network;
a step in which the mobile terminal stores the advertisement content transmitted from the advertisement system; and
a step in which when a transmission key is inputted for a text message transmission after the mobile terminal stores the advertisement content, the advertisement content stored while the previous text message is being transmitted is reproduced while the text message is being transmitted to the SMS server.

8. A method for providing an advertisement service by using text messages according to claim 7, wherein when a transmission key is inputted from the text message transmission, said mobile terminal displays a selection window for selecting whether or not the advertisement content is reproduced, for thereby selecting whether or not the advertisement content is reproduced.

9. A method for providing an advertisement service by using text messages according to claim 7, wherein said advertisement content is selected depending on a personal information of a sender and is sent.

10. A method for providing an advertisement service by using text messages according to claim 9, wherein said personal information of the sender is at least one of age, sex, occupation, favorite field and regional information.

11. A method for providing an advertisement service by using text messages according to claim 7, wherein said advertisement content includes a motion image, a still image and text.

12. A method for providing an advertisement service by using text messages according to claim 7, wherein said mobile terminal divides a screen for displaying an information which shows that the advertisement content and the text message are being sent and displays the same.
